(19) United States
(12) Patent Application Publication
(10) Pub. No.: US 2026/0302250 A1
(43) Pub. Date: Oct. 1, 2026

(54) POSITIVE ELECTRODE ACTIVE MATERIALS, METHODS OF PREPARING THE SAME, POSITIVE ELECTRODE FOR THE ALL-SOLID-STATE RECHARGEABLE BATTERY, AND ALL-SOLID-STATE RECHARGEABLE BATTERIES

(71) Applicant: SAMSUNG SDI CO., LTD., Yongin-si, Gyeonggi-do (KR)

(72) Inventors: Juyun KIM, Yongin-si, Gyeonggi-do (KR); Myoungki MIN, Yongin-si, Gyeonggi-do (KR); Soomin HWANG, Yongin-si, Gyeonggi-do (KR); Seulchan PARK, Yongin-si, Gyeonggi-do (KR); Jin-Woo KIM, Yongin-si, Gyeonggi-do (KR); Hoseon YOU, Yongin-si, Gyeonggi-do (KR)

(73) Assignee: SAMSUNG SDI CO., LTD., Yongin-si, Gyeonggi-do (KR)

(21) Appl. No.: 18/880,489

(22) PCT Filed: Jan. 9, 2024
(86) PCT No.: PCT/KR2024/000419

§ 371 Date: Dec. 31, 2024

(30) Foreign Application Priority Data
Apr. 6, 2023 (KR) 10-2023-0045631

(51) Int. Cl. H01M 4/62; C09D 7/61; C09D 171/02; H01M 4/131; H01M 4/36; H01M 4/525; H01M 10/0525

(52) U.S. Cl. CPC H01M 4/628; C09D 7/61; C09D 171/02; H01M 4/131; H01M 4/366; H01M 4/525; H01M 10/0525

(57) ABSTRACT

Disclosed are a positive electrode active material, and a positive electrode for an all-solid-state rechargeable battery and an all-solid-state rechargeable battery including the same, the positive electrode active material including a positive electrode active material particles including a lithium transition metal composite oxide, and a coating layer on a surface of the positive electrode active material particles, wherein the coating layer includes an organic material and a lithium salt, and the organic material includes a (meth)acrylate including an alkylene glycol unit, an ether including an alkylene glycol unit, or a combination thereof.

### TECHNICAL FIELD

Positive electrode active materials, methods of preparing the same, positive electrode for an all-solid-state rechargeable battery, and all-solid-state rechargeable battery are disclosed.

### BACKGROUND ART

Recently, as a risk of explosion of a battery using a liquid electrolyte has been reported, development of an all-solid-state rechargeable battery has been actively conducted. However, a solid electrolyte, compared to the liquid electrolyte, has problems of low ionic conductivity, resistance on the interface with solid particles of a positive electrode active material and the like in a battery, deterioration of the ion conduction performance by formation of a depletion layer by solid-to-solid bonding, and the like.

The positive electrode for an all-solid-state rechargeable battery is composed of inorganic materials such as a positive electrode active material, a solid electrolyte, and a conductive material. Here, the movement of lithium ions at the contact point between the solid particles of the positive electrode active material and the solid electrolyte has a major impact on battery performance. However, the volume change of the positive electrode active material that occurs during the charge/discharge process limits the physical bonding between the positive electrode active material and the solid electrolyte, and research is continuously being conducted to improve the contact between particles to overcome the problem.

Conventional positive electrodes for all-solid-state rechargeable batteries use a method of fixing the positive electrode active material and solid electrolyte using a fluorine-based binder, etc., to maintain the electrode plates. However, there is a problem that fluorine-based binders can hinder lithium movement and reduce the performance of all-solid-state rechargeable batteries.

### DISCLOSURE

By improving the interfacial adhesive strength between a positive electrode active material and a solid electrolyte and effectively preventing the deterioration of battery performance due to volume change of the positive electrode active material due to charge and discharge, the capacity characteristics and cycle-life characteristics of an all-solid-state rechargeable battery are improved.

In an embodiment, a positive electrode active material includes positive electrode active material particles including a lithium transition metal composite oxide, and a coating layer on a surface of the positive electrode active material particles, wherein the coating layer includes an organic material and a lithium salt, and the organic material includes a (meth)acrylate including an alkylene glycol unit, an ether including an alkylene glycol unit, or a combination thereof.

In another embodiment, a method for preparing a positive electrode active material includes mixing an organic material and a lithium salt to prepare a composite, and mixing the composite with positive electrode active material particles including a lithium transition metal composite oxide and drying the composite to coat the surface of the positive electrode active material particles with the composite, wherein the organic material includes a (meth)acrylate including an alkylene glycol unit, an ether including an alkylene glycol unit, or a combination thereof.

In another embodiment, a positive electrode for an all-solid-state rechargeable battery includes the positive electrode active material and a sulfide-based solid electrolyte.

In another embodiment, an all-solid-state rechargeable battery includes the aforementioned positive electrode, a negative electrode, and a solid electrolyte layer between the positive electrode and negative electrode.

According to an embodiment, a positive electrode active material is a material having an organic material and a lithium salt coated on the surface, which improves the interfacial adhesive strength between the positive electrode active material and the solid electrolyte, thereby facilitating the movement of lithium ions, effectively preventing degradation of battery performance due to volume change of the positive electrode active material according to charge and discharge, and improving the overall performance of the all-solid-state rechargeable battery, such as capacity characteristics and cycle-life characteristics.

### DESCRIPTION OF THE DRAWINGS

FIGS. 1 and 2 are schematic cross-sectional views of an all-solid rechargeable battery according to an embodiment.

FIG. 3 is a graph showing the discharge capacity according to the number of cycles for the all-solid-state rechargeable battery cells of Example 1 and Comparative Examples 1 and 2.

FIG. 4 is a graph showing the capacity retention rates according to the number of cycles for the all-solid-state rechargeable battery cells of Example 1 and Comparative Examples 1 and 2.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscope photograph or a scanning electron microscope photograph. Alternatively, it is possible to obtain an average particle diameter value by measuring using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, A+B, and the like.

### Positive Electrode Active Material

In an embodiment, a positive electrode active material includes positive electrode active material particles including a lithium transition metal composite oxide, and a coating layer on a surface of the positive electrode active material particles, wherein the coating layer includes an organic material and a lithium salt, and the organic material includes a (meth)acrylate including an alkylene glycol unit, an ether including an alkylene glycol unit, or a combination thereof.

The positive electrode active material has an excellent adhesive strength to a solid electrolyte because a specific organic material and lithium salt are coated on the surface, and even if the volume of the positive electrode active material changes depending on charge and discharge, stable contact between solid particles within the positive electrode is secured, and accordingly, lithium ions can move smoothly over a long cycle, so that the overall performance of the all-solid-state rechargeable battery can be improved. When a coated positive electrode active material according to an embodiment is applied to a positive electrode, the adhesive strength between solid particles is higher and the movement of lithium ions is further promoted compared to a case where the same organic material and lithium salt are simply dispersed in the positive electrode, so that the cycle-life stability of the all-solid-state battery can be further improved.

In the coating layer, the organic material may be an acrylate or ether including an alkylene glycol unit, and such an organic material has low reactivity with a sulfide-based solid electrolyte, excellent oxidation resistance, and can implement high adhesive strength. For example, polyethylene glycol (PEG) has a high reactivity with sulfide-based solid electrolytes, making it difficult to apply it to the positive electrode of an all-solid-state battery, and general acrylic binders that do not include alkylene glycol units have low oxidation resistance, and thus the binder itself may be decomposed in an all-solid-state battery manufactured under high temperature and high-pressure conditions, making them unsuitable.

The alkylene glycol may be, but is not limited to, ethylene glycol, propylene glycol, or neopentyl glycol, and may be, for example, ethylene glycol. The number of the alkylene glycol unit in the organic material can be from 1 to 200, for example from 1 to 5, or from 20 to 200. Additionally, the number of (meth)acrylate groups in the (meth)acrylate including the alkylene glycol unit may be 1 to 4, and for example, may be 1 or 2. The number of the ether group in the ether including the alkylene glycol unit may be 1 to 4, and for example, may be 1 or 2. The ether group may be linear or cyclic. The organic material may include an acrylate group alone, an ether group alone, or both an acrylate group and an ether group.

Specific examples of the (meth)acrylate including the alkylene glycol unit, the ether including the alkylene glycol unit, or the combination thereof may include the following compounds. For example, they may include poly(ethylene glycol) diacrylate (PEGDA), poly(ethylene glycol) monoacrylate (PEGMA), poly(propylene glycol) diacrylate (PPGDA), poly(propylene glycol) dimethacrylate (PPGDMA), di(ethylene glycol) diacrylate (DEGDA), tri(ethylene glycol) diacrylate (TEGDA), tetra(ethylene glycol) diacrylate (TTEGDA), di(propylene glycol) diacrylate (DPGDA), tri(propylene glycol) diacrylate (TPGDA), ethoxylated trimethyloIpropane triacrylate (ETPTA), poly(ethylene glycol) methyl ether methacrylate (PEGDMA), poly(ethylene glycol) dimethyl ether (PEGDME; polyglime), tri(ethylene glycol) dimethyl ether (triglyme), tetra(ethylene glycol) dimethyl ether (TEGDME, tetraglyme), or a combination thereof.

The organic material may include, among these, for example, poly(ethylene glycol) diacrylate (PEGDA), poly(ethylene glycol) monoacrylate (PEGMA), poly(ethylene glycol) methyl ether methacrylate (PEGDMA), poly(ethylene glycol) dimethyl ether (PEGDME; polyglime), or a combination thereof, and these have low reactivity with a sulfide-based solid electrolyte, high oxidation resistance, and high adhesive strength, making them suitable for application as a coating component of a positive electrode active material for an all-solid-state rechargeable battery.

The organic material, i.e., the (meth)acrylate including the alkylene glycol unit and the ether including the alkylene glycol units, may each independently have a number average molecular weight of 200 g/mol to 2,000 g/mol. Their number average molecular weight may be, for example, from 250 g/mol to 1,500 g/mol, or from 300 g/mol to 1,200 g/mol. When applying an organic material having this molecular weight, a thin coating layer can be formed while implementing excellent adhesive strength.

In the coating layer, the organic material and lithium salt may form a kind of composite.

In the coating layer, the organic material may be included in an amount of 20 to 90 wt %, and the lithium salt may be included in an amount of 10 to 80 wt %, based on a total of 100 wt % of the organic material and the lithium salt. When mixed in this ratio, the coating layer can improve performance, such as cycle-life stability, of an all-solid-state rechargeable battery by facilitating the movement of lithium ions while implementing appropriate adhesive strength. A weight ratio of the organic material to the lithium salt in the coating layer may be 2:8 to 9:1, for example, 2:8 to 8:2, 3:7 to 7:3, or 2:8 to 6:4.

A total content of the organic material and the lithium salt may be 0.1 parts by weight to 10 parts by weight, for example 0.1 parts by weight to 8 parts by weight, 0.1 parts by weight to 6 parts by weight, 0.1 parts by weight to 5 parts by weight, 0.5 parts by weight to 4 parts by weight, or 1 part by weight to 3 parts by weight based on 100 parts by weight of the positive electrode active material particles.

Additionally, the organic material may be included in an amount of 0.05 wt % to 5 wt %, for example, 0.05 wt % to 4 wt %, 0.1 wt % to 3 wt %, or 0.5 wt % to 2 wt % based on 100 wt % of the positive electrode active material. The lithium salt may be included in an amount of 0.05 wt % to 5 wt %, for example, 0.05 wt % to 4 wt %, 0.1 wt % to 3 wt %, or 0.5 wt % to 2 wt % based on 100 wt % of the positive electrode active material.

The lithium salt may be applied without limitation on type, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro(oxalato)borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide-based lithium salt such as LiTFSI, LiFSI, LiBETI, or a combination thereof, which may facilitate the movement of lithium ions on the surface of the positive electrode active material.

The coating layer may exist in the form of an island or a continuous film on the surface of the positive electrode active material particles.

Because the coating layer is composed of an organic material and a lithium salt, it may be formed with a very thin thickness, thereby increasing adhesive strength and facilitating lithium ions without increasing resistance within the battery. A thickness of the coating layer may be from 1 nm to 50 nm, for example from 1 nm to 40 nm, from 1 nm to 30 nm, from 1 nm to 20 nm, from 1 nm to 10 nm, or from 2 nm to 10 nm.

The positive electrode active material particles including the lithium transition metal composite oxide correspond to a kind of core, and commonly used positive electrode active material particles can be applied without limitation.

The lithium transition metal composite oxide may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

The lithium transition metal composite oxide may be, for example, a lithium nickel-based oxide represented by Chemical Formula 1, a lithium cobalt-based oxide represented by Chemical Formula 2, a lithium iron phosphate-based compound represented by Chemical Formula 3, or a cobalt-free lithium nickel-manganese-based oxide represented by Chemical Formula 4.

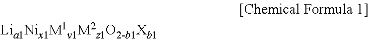

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more elements selected from Al, B, Ba, Ca, Ce, Co, Cr, Cu, Fe, Mg, Mn, Mo, Nb, Si, Sn, Sr, Ti, V, W, Zn, and Zr, and X is one or more elements selected from F, P, and S,

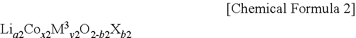

wherein, in Chemical Formula 2, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S,

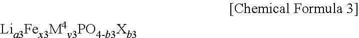

wherein, in Chemical Formula 3, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S,

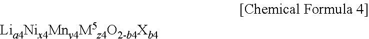

wherein, in Chemical Formula 4, 0.9≤a4≤1.8, 0.8≤x4≤1, 0≤y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

The lithium transition metal composite oxide may be a lithium nickel-based oxide represented by Chemical Formula 1, and may be, for example, a high nickel-based oxide. That is, a content of nickel based on 100 mol % of metals excluding lithium in the lithium transition metal composite oxide may be 80 mol % or more, or 90 mol % or more, or 91 mol % or more, or 94 mol % or more. In Chemical Formula 1, 0.8≤x1≤1, 0≤y1≤0.2, and 0≤z1≤0.2, or 0.9≤x1≤1, 0≤y1≤0.1, and 0≤z1≤0.1, or 0.91≤x1≤1, 0≤y1≤0.09, and 0≤z1≤0.09, 0.94≤x1≤1, 0≤y1≤0.06, and 0≤z1≤0.06. For example, 0.8≤x1<1, 0<y1≤0.2, and 0≤z1≤0.2, or 0.9≤x1≤1, 0≤y1≤0.1, and 0≤z1≤0.1. The high nickel oxide may realize high capacity, making them suitable for application to high-capacity, high-density all-solid-state rechargeable batteries that are in recent demand. However, because the positive electrode active material including a high nickel-based oxide has a large volume change of about 8% due to charge and discharge, it is difficult to maintain long-term contact with the solid electrolyte. However, by introducing a coating layer according to an embodiment, it is possible to implement long-term adhesive strength between solid particles while facilitating the movement of lithium ions.

The average particle diameter (D50) of the positive electrode active material particle may be 1 μm to 25 μm, for example 2 μm to 20 μm, or 3 μm to 18 μm. For example, the positive electrode active material particles may include small particles having an average particle diameter (D50) of 1 μm to 9 μm and large particles having an average particle diameter (D50) of 10 μm to 20 μm. In this case, the small particles may be included in an amount of 5 to 40 wt % and the large particles may be included in an amount of 60 to 95 wt %, for example, the small particles may be included in an amount of 10 to 30 wt % and the large particles may be included in an amount of 70 to 90 wt % based on a total of 100 wt % of the small particles and the large particles. If the positive electrode active material particle is composed of a mixture of small particles and large particles, a high energy density battery can be implemented.

Here, the average particle size may be obtained by randomly measuring the size (diameter or length of the major axis) of about 20 particles in an electron microscope photograph such as a scanning electron microscope to obtain a particle size distribution, and taking the diameter (D50) of the particles having a cumulative volume of 50 volume % in the particle size distribution as the average particle size.

The positive electrode active material particles may be in the form of secondary particles formed by agglomeration of a plurality of primary particles, in the form of single particles, or in the form of a mixture of these.

For example, both small particles and large particles can be in the form of secondary particles in which a plurality of primary particles are agglomerated, and these secondary particles may be in the form of a kind of polycrystal.

Alternatively, the small particles may be in the form of single particles, and the large particles may be in the form of secondary particles formed by agglomeration of a plurality of primary particles. Here, the single particles exist alone without a grain boundary within the particle, is composed of one particle, and may be a single particle, a monolith structure, a one body structure, or a non-agglomerated particle, in which particles are not agglomerated with each other but exist as an independent phase in terms of morphology, and may be expressed as a single particle (one body particle, single grain), for example, as a single crystal.

Meanwhile, the positive electrode active material may further include a buffer layer between the positive electrode active material particles and the coating layer. The buffer layer can lower the interfacial resistance between positive electrode active material particles or between positive electrode active material and solid electrolyte particles, and improve the initial charge/discharge efficiency and cycle-life characteristics of the battery.

The buffer layer may include a lithium compound and a metal oxide. The lithium compound means a compound including lithium, and the metal oxide means an oxide including a metal other than lithium. Here, the metal is a concept that includes a general metal, a transition metal, and a semi-metal. In the metal oxide, the metal may be one or more elements selected from, for example, Al, B, Ca, Ce, Cr, Fe, Mg, Mo, Nb, Si, Sn, Sr, Ta, V, W, and Zr. The lithium compound may be, for example, a carbonate, hydroxide, oxide, or the like including lithium, for example, Li₂CO₃, LiOH, or a combination thereof.

The buffer layer is excellent in improving the performance of the positive electrode active material by facilitating the movement of lithium ions and electron conduction, while lowering the interfacial resistance between the positive electrode active material and the solid electrolyte particles. The buffer layer may be amorphous. That is, the lithium compound and metal oxide in the buffer layer may be amorphous. When an amorphous compound is formed as a buffer layer on the surface of the positive electrode active material, the interfacial resistance between the positive electrode active material and the solid electrolyte particles can be lowered without impairing the performance of the positive electrode active material, thereby improving the capacity characteristics and cycle-life characteristics of the all-solid-state rechargeable battery.

The thickness of the buffer layer may be approximately 1 nm to 20 nm, for example 2 nm to 15 nm, or 5 nm to 10 nm. The buffer layer is formed with such a very thin thickness that it can effectively reduce the interfacial resistance between solid particles without impairing the performance of the positive electrode active material.

### Method for Preparing Positive Electrode Active Material

In an embodiment, a method for preparing a positive electrode active material includes mixing an organic material and a lithium salt to prepare a composite, and mixing the composite with positive electrode active material particles including a lithium transition metal composite oxide and drying the composite to coat the surface of the positive electrode active material particles with the composite, wherein the organic material includes a (meth)acrylate including an alkylene glycol unit, an ether including an alkylene glycol unit, or a combination thereof. The coated positive electrode active material described above can be prepared using this method.

Because the organic material, lithium salt, and positive electrode active material particles have been described above, detailed descriptions thereof are omitted.

The organic material may be mixed in an amount of 0.05 parts by weight to 5 parts by weight, for example 0.05 parts by weight to 4 parts by weight, 0.1 parts by weight to 3 parts by weight, or 0.5 parts by weight to 2 parts by weight based on 100 parts by weight of the positive electrode active material particles.

In addition, the lithium salt may be mixed in an amount of 0.05 parts by weight to 5 parts by weight, for example, 0.05 parts by weight to 4 parts by weight, 0.1 parts by weight to 3 parts by weight, or 0.5 parts by weight to 2 parts by weight based on 100 parts by weight of the positive electrode active material particles.

A weight ratio of the organic material and the lithium salt may be from 2:8 to 9:1, for example, from 2:8 to 8:2, from 3:7 to 7:3, or from 2:8 to 6:4. The drying may be performed at a temperature range of 60° C. to 150° C. and may be performed for 1 hour to 48 hours.

The coating process according to an embodiment may be a wet coating method or a solid-phase coating method. For example, the coating may be performed by dissolving the organic material and the lithium salt in a solvent, adding positive electrode active material particles, mixing, and then drying. By applying the wet coating method, a thin and uniform coating layer can be formed. Alternatively, the positive electrode active material particles and the organic material and lithium salt may be mixed without a solvent, for example, in a Thinky mixer. When the solid coating method is applied, a coating layer of appropriate thickness may be formed without damaging the positive electrode active material.

Positive Electrode for all-Solid-State Rechargeable Battery

In an embodiment, a positive electrode for an all-solid-state rechargeable battery includes the positive electrode active material described above and a sulfide-based solid electrolyte. Specifically, the positive electrode according to an embodiment includes a current collector and a positive electrode active material layer on the current collector, wherein the positive electrode active material layer includes the positive electrode active material described above and a sulfide-based solid electrolyte, and may optionally include a conductive material and/or a binder. The above-mentioned positive electrode active material has a coating layer formed on its surface including a specific organic material and a lithium salt, and the coating layer has high oxidation resistance, high adhesive strength, and high lithium ionic conductivity while being non-reactive with a sulfide-based solid electrolyte, and is therefore suitable for application to the positive electrode of an all-solid-state rechargeable battery using a sulfide-based solid electrolyte.

### Sulfide-Based Solid Electrolyte

The sulfide-based solid electrolyte may include for example Li₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally performing heat treatment. Within the above mixing ratio range, a sulfide-based solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of sulfur-containing raw materials for preparing a sulfide-based solid electrolyte. The mechanical milling is to make starting materials into particulates by putting the starting materials in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte particles according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be, for example, represented by the chemical formula, LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, it may be represented by the chemical formula of Li₇₋ₓPS₆₋ₓAₓ (wherein x is 0.2 or more and 1.8 or less, and A is F, Cl, Br, or I). Specifically, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide-based solid electrolyte including such argyrodite-type sulfide may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

The argyrodite-type sulfide-based solid electrolyte may be prepared, for example, by mixing lithium sulfide and phosphorus sulfide, and optionally lithium halide. Heat treatment may be performed after mixing them. The heat treatment may include, for example, two or more heat treatment steps. The method of preparing the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The average particle size (D50) of the sulfide-based solid electrolyte particles may be, for example, 0.1 μm to 5.0 μm, and may be small particles of 0.1 μm to 1.9 μm or large particles of 2.0 μm to 5.0 μm. For example, the average particle diameter (D50) of the sulfide-based solid electrolyte included in the positive electrode may be about 0.1 μm to 1.9 μm, which may be smaller than the average particle diameter of the solid electrolyte included in the solid electrolyte layer. The solid electrolyte satisfying the above average particle size range can effectively penetrate between positive electrode active materials, and has excellent contact with the positive electrode active material and connectivity between solid electrolyte particles. The average particle diameter may be measured using an electron microscope image, and for example, a particle size distribution may be obtained by measuring the size (diameter or length of the major axis) of about 20 particles in a scanning electron microscope image, and D50 may be calculated therefrom.

Based on the total weight of the positive electrode active material layer, the solid electrolyte may be included in an amount of 0.1 wt % to 35 wt %, for example, 1 wt % to 35 wt %, 5 wt % to 30 wt %, 8 wt % to 25 wt %, or 10 wt % to 20 wt %.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Conductive Material

The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. and in the form of a metal powder or a metal fiber; a conductive polymer such as a polyphenylene derivative; or a conductive material including a mixture thereof.

A content of the conductive material in the positive electrode active material layer may be 0.1 wt % to 5 wt % based on the total weight of the positive electrode active material layer.

### Binder

According to an embodiment, the positive electrode can realize excellent adhesive strength between solid particles without using a separate binder by including the above-described positive electrode active material coated with an organic material. In particular, a fluorine-based binder can limit the movement of lithium in the positive electrode in an all-solid-state rechargeable battery, and in an embodiment, excellent adhesive strength can be achieved even without including a fluorine-based binder. In other words, the positive electrode for an all-solid-state rechargeable battery according to an embodiment of the present invention may be a positive electrode that does not include a fluorine-based binder.

However, the positive electrode may further include various binders as needed. The binder may be, for example, a polymer including polyvinyl alcohol, carboxymethyl cellulose, hydroxypropyl cellulose, diacetyl cellulose, ethylene oxide, polyvinyl pyrrolidone, polyurethane, polyethylene, polypropylene, polyalkyl (meth)acrylate, a styrene-butadiene rubber, an acrylated styrene-butadiene rubber, a nitrile-butadiene rubber, a hydrogenated nitrile-butadiene rubber, an acrylic rubber, a natural rubber, an epoxy resin, nylon, etc.

A content of the binder in the positive electrode active material layer may be approximately 0.1 wt % to 5 wt % based on the total weight of the positive electrode active material layer.

As the above positive electrode collector, aluminum foil or stainless steel foil such as SUS may be used, but is not limited thereto.

### All-Solid-State Rechargeable Battery

In an embodiment, an all-solid-state rechargeable battery includes the aforementioned positive and negative electrodes and a solid electrolyte layer between the positive and negative electrodes. The all-solid-state rechargeable battery may be an all-solid-state battery, an all-solid-state rechargeable lithium battery, etc.

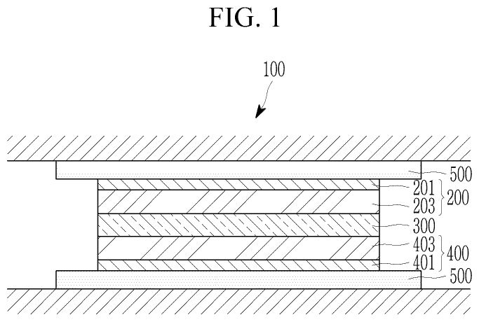

FIG. 1 is a cross-sectional view schematically illustrating an all-solid-state battery according to an embodiment. Referring to FIG. 1, the all-solid-state rechargeable battery 100 may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is inserted into a case such as a pouch and the like. The all-solid-state rechargeable battery 100 may further include at least one elastic layer 500 on the outside of at least either one of the positive electrode 200 and the negative electrode 400. FIG. 1 shows one electrode assembly including the negative electrode 400, the solid electrolyte layer 300, and the positive electrode 200, but two or more electrode assemblies may be stacked to manufacture an all-solid-state rechargeable battery.

### Negative Electrode

The negative electrode for an all-solid-state rechargeable battery includes a current collector, and a negative electrode active material layer on the current collector. The negative electrode active material layer may include a negative electrode active material, and may further include a binder and/or a conductive material.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be mixed with the carbon-based negative electrode active material. When using a mixture of Si-based negative electrode active material or Sn-based negative electrode active material and carbon-based negative electrode active material, a mixing ratio thereof may be 1:99 to 90:10 by weight.

In the negative electrode active material layer, the negative electrode active material may be included in an amount of 95 wt % to 99 wt % based on the total weight of the negative electrode active material layer.

In an embodiment, the negative electrode active material layer further includes a binder, and may optionally further include a conductive material. The content of the binder in the negative electrode active material layer may be 1 wt % to 5 wt % based on the total weight of the negative electrode active material layer. In addition, when the conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may include, for example polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for the all-solid-state rechargeable battery may be a precipitation-type negative electrode. The precipitation-type negative electrode may be a negative electrode which has no negative electrode active material during the assembly of a battery but in which a lithium metal and the like are precipitated or electrodeposited on the negative electrode during the charge of the battery and serve as a negative electrode active material.

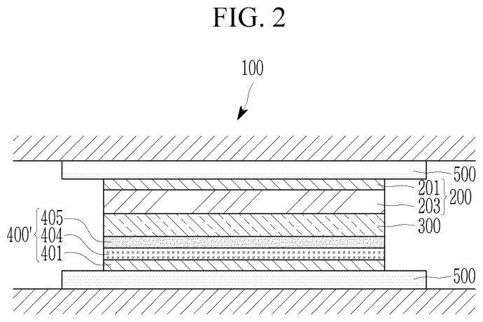

FIG. 2 is a schematic cross-sectional view of an all-solid-state rechargeable battery including a precipitation-type negative electrode. Referring to FIG. 2, the precipitation-type negative electrode 400′ may include the current collector 401 and a negative electrode coating layer 405 disposed on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. When the metal is present in particle form, an average particle diameter (D50) thereof may be less than or equal to 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

When the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state rechargeable battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Solid Electrolyte Layer

The solid electrolyte layer 300 may include solid electrolyte particles and optionally a binder. The solid electrolyte particles may include a sulfide-based solid electrolyte, an oxide-based solid electrolyte, etc. Because the content of the sulfide-based solid electrolyte is as described above, a detailed description thereof is omitted.

The oxide-based solid electrolytes may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Ta, Te, Nb, Zr, or a combination thereof; x is an integer from 1 to 10), or a mixture thereof.

Meanwhile, the average particle diameter (D50) of the solid electrolyte included in the solid electrolyte layer 300 may be larger than the average particle diameter (D50) of the solid electrolyte included in the positive electrode 200. In this case, the energy density of the all-solid-state rechargeable battery can be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When the particle size ranges are satisfied, the energy density of the all-solid-state rechargeable battery is maximized while the transfer of lithium ions is facilitated, so that resistance is suppressed, and thus the overall performance of the all-solid-state rechargeable battery can be improved. Herein, the average particle diameter (D50) of the solid electrolyte may be measured through a particle size analyzer using a laser diffraction method.

The solid electrolyte layer may further include a binder in addition to the solid electrolyte particles. Here, the binder may include a styrene butadiene rubber, polytetrafluoroethylene, polyvinylidene fluoride, polyethylene, an acrylate-based polymer, or a combination thereof, but is not limited thereto. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. Since a forming process of the solid electrolyte layer is well known in the art, a detailed description thereof will be omitted.

A thickness of the solid electrolyte layer may be, for example, 10 μm to 150 μm.

The solid electrolyte layer may further include an alkali metal salt and/or an ionic liquid and/or a conductive polymer.

The alkali metal salt may be, for example, a lithium salt. A content of the lithium salt in the solid electrolyte layer may be greater than or equal to 1 M, for example, 1 M to 4 M. In this case, the lithium salt may improve ionic conductivity by improving lithium ion mobility of the solid electrolyte layer.

The lithium salt may be applied without type limitations, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro (oxalato)borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide-based lithium salt such as LiTFSI, LiFSI, LiBETI, or a combination thereof. The imide-based lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The all-solid-state rechargeable battery may be a unit cell having a structure of a positive electrode/solid electrolyte layer/negative electrode, a bicell having a structure of a negative electrode/solid electrolyte layer/positive electrode/solid electrolyte layer/negative electrode, or a stacked battery in which the structure of the unit cell is repeated.

The shape of the all-solid-state rechargeable battery is not particularly limited, and may be, for example, a coin type, a button type, a sheet type, a stack type, a cylindrical shape, a flat type, and the like. In addition, the all-solid-state rechargeable battery may be applied to a large-sized battery used in an electric vehicle or the like. For example, the all-solid-state rechargeable battery may also be used in a hybrid vehicle such as a plug-in hybrid electric vehicle (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples of the present invention and comparative examples are described. It is to be understood, however, that the examples are for the purpose of illustration and are not to be construed as limiting the present invention.

### Example 1

### 1. Preparation of Positive Electrode Active Material

The positive electrode active material particles were prepared by mixing small particles with an average particle size of about 4 μm and large particles with an average particle size of about 18 μm in a weight ratio of 3:7, with a composition of LiNi_{0.944}Co_{0.04}Al_{0.012}Mn_{0.004}O₂ and a buffer layer of lithium zirconium oxide formed thereon.

After mixing 0.5 parts by weight of poly(ethylene glycol) diacrylate (PEGDA) having a number average molecular weight of approximately 700 g/mol and 0.75 parts by weight of LiTFSI in a diethyl carbonate (DEC) solvent, 100 parts by weight of the prepared positive electrode active material particles were added and mixed. After removing the solvent, the coated positive electrode active material was manufactured by drying at 60° C. for 5 min and then vacuum-dried at 80° C. for 2 hours.

### 2. Manufacturing of Positive Electrode

In an octyl acetate solvent, 85 wt % of the manufactured coated positive electrode active material, 13.5 wt % of sulfide-based solid electrolyte particles (Li₆PS₅Cl, D50=0.85 μm), 1.0 wt % of an acrylic binder, and 0.5 wt % of a carbon nanotube conductive material were mixed to manufacture a positive electrode composition. This was coated on the SUS collector with a bar coater, then compressed and dried to manufacture a positive electrode.

### 3. Manufacturing of Negative Electrode

An Ag/C composite was prepared by mixing carbon black having a primary particle size (D50) of about 30 nm and silver (Ag) having an average particle size (D50) of about 60 nm in a weight ratio of 3:1, and 0.25 g of the composite was added to 2 g of an NMP solution including 7 wt % of polyvinylidene fluoride binder and mixed to prepare a negative electrode coating layer composition. This was coated on a nickel foil current collector using a bar coater and vacuum dried to prepare a precipitation-type negative electrode in which a negative electrode coating layer was formed on the current collector.

### 4. Manufacturing of Solid Electrolyte Layer

A composition for forming a solid electrolyte layer was prepared by adding and mixing a sulfide-based solid electrolyte (Li₆PS₅Cl, D50=3 μm) and an organic dispersant to an IBIB solvent including an acrylic binder. The composition includes 98.7 wt % of a sulfide-based solid electrolyte, 1.0 wt % of a binder, and 0.3 wt % of an organic dispersant. The composition is cast on a PET release film and dried at room temperature to manufacture a solid electrolyte layer.

5. Manufacturing of all-Solid-State Rechargeable Battery Cell

After stacking the positive electrode, solid electrolyte layer, and negative electrode in that order, it was sealed in a pouch shape and subjected to warm isostatic press at a high temperature of 80° C. and 500 MPa for 30 minutes to manufacture an all-solid-state rechargeable battery cell.

### Comparative Example 1

A positive electrode and an all-solid-state rechargeable battery cell were manufactured in substantially the same manner as in Example 1, except that the positive electrode active material particles were not coated with an organic material and a lithium salt and were prepared by mixing small particles with an average particle size of about 4 μm and large particles with an average particle size of about 18 μm in a weight ratio of 3:7, with a composition of LiNi_{0.944}Co_{0.04}Al_{0.012}Mn_{0.004}O₂ and a buffer layer of lithium zirconium oxide formed thereon.

### Comparative Example 2

A method of adding PEGDA and LiTFSI to the positive electrode composition was applied without coating PEGDA and LiTFSI on the positive electrode active material particles. That is, 85 wt % of the positive electrode active material of Comparative Example 1, 13.5 wt % of sulfide-based solid electrolyte particles (Li₆PS₅Cl, D50=0.85 μm), 1.0 wt % of an acrylic binder, and 0.5 wt % of a carbon nanotube conductive material were mixed in an octyl acetate solvent, and 0.5 wt % of PEGDA and 0.75 wt % of LiTFSI were added based on 100 wt % of the positive electrode active material and mixed together to prepare a positive electrode composition according to Comparative Example 2. This was coated on the current collector using a bar coater, then compressed and dried to manufacture a positive electrode. The process thereafter was carried out using substantially the same method as Example 1 to manufacture an all-solid-state rechargeable battery cell.

### Comparative Example 3

A positive electrode active material and an all-solid-state rechargeable battery cell were manufactured in substantially the same manner as in Example 1, except that polyethylene glycol (PEG) having a weight average molecular weight of 1,000 g/mol was used instead of PEGDA.

### Comparative Example 4

A positive electrode active material and an all-solid-state rechargeable battery cell were manufactured in substantially the same manner as in Example 1, except that ethylhexyl acrylate having a weight-average molecular weight of 4,000 g/mol was used instead of PEGDA.

### Evaluation Example: Cycle-life Characteristics Evaluation

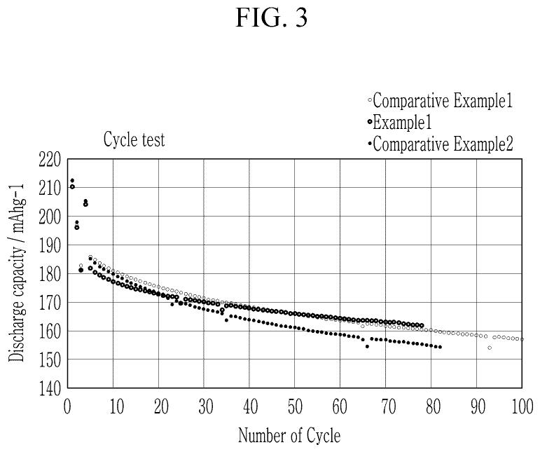

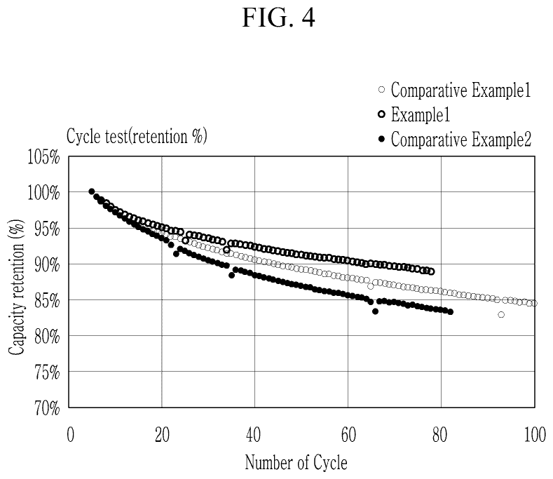

For the battery cells manufactured in Example 1 and Comparative Examples 1 and 2, the initial charge/discharge was performed by charging at a constant current of 0.1 C at 45° C. to an upper limit voltage of 4.25 V, at a constant voltage of 0.05 C, and then discharging at 0.1 C to a cut-off discharge voltage of 2.5 V. Thereafter, the cycle-life characteristics were evaluated by repeating the cycle of charging at 0.33 C and discharging at 0.33 C in the voltage range of 2.5 V to 4.25 V at 45° C. for 100 times, and the discharge capacity according to the number of cycles is shown in FIG. 3, and the capacity retention rate according to the number of cycles is shown in FIG. 4. The capacity retention rate is a ratio of the discharge capacity in each cycle to the discharge capacity in the first cycle, and the unit is %.

Referring to FIG. 3, the discharge capacities of Example 1 and Comparative Example 1 are reversed around the 50th cycle, and that the discharge capacity of Example 1 is higher than that of Comparative Example 1 after the 50th cycle. Referring to FIG. 4, the capacity retention rate of Example 1 is higher than that of Comparative Examples 1 and 2 throughout the cycles.

Meanwhile, in the case of Comparative Example 3, PEG was reactive with the sulfide-based solid electrolyte, thereby increasing the resistance of the battery, and in the case of Comparative Example 4, the first coulombic efficiency of the battery decreased and the cycle-life characteristics also deteriorated due to the oxidation resistance problem of the acrylic binder.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery 200: positive electrode
201: positive electrode current collector 203: positive electrode active material layer
300: solid electrolyte layer 400: negative electrode
401: negative electrode current collector 403: negative electrode active material layer
400′: precipitation-type negative electrode 404: lithium metal layer
405: negative electrode coating layer 500: elastic layer

1. A positive electrode active material, comprising
positive electrode active material particles including a lithium transition metal composite oxide, and
a coating layer on a surface of the positive electrode active material particles,
wherein the coating layer includes an organic material and a lithium salt, and
the organic material includes a (meth)acrylate including an alkylene glycol unit, an ether including an alkylene glycol unit, or a combination thereof.

2. The positive electrode active material as claimed in claim 1, wherein the alkylene glycol is ethylene glycol, propylene glycol, or neopentyl glycol.

3. The positive electrode active material as claimed in claim 1, wherein the (meth)acrylate including the alkylene glycol unit, the ether including the alkylene glycol unit, or the combination thereof includes poly(ethylene glycol) diacrylate (PEGDA), poly(ethylene glycol) monoacrylate (PEGMA), poly(propylene glycol) diacrylate (PPGDA), poly(propylene glycol) dimethacrylate (PPGDMA), di(ethylene glycol) diacrylate (DEGDA), tri(ethylene glycol) diacrylate (TEGDA), tetra(ethylene glycol) diacrylate (TTEGDA), di(propylene glycol) diacrylate (DPGDA), tri(propylene glycol) diacrylate (TPGDA), ethoxylated trimethylolpropane triacrylate (ETPTA), poly(ethylene glycol) methyl ether methacrylate (PEGDMA), poly(ethylene glycol) dimethyl ether (PEGDME; polyglime), tri(ethylene glycol) dimethyl ether (triglyme), tetra(ethylene glycol) dimethyl ether(TEGDME, tetraglyme), or a combination thereof.

4. The positive electrode active material as claimed in claim 1, wherein
the (meth)acrylate including the alkylene glycol unit, the ether including the alkylene glycol unit, or the combination thereof includes poly(ethylene glycol) diacrylate (PEGDA), poly(ethylene glycol) monoacrylate (PEGMA), poly(ethylene glycol) methyl ether methacrylate (PEGDMA), poly(ethylene glycol) dimethyl ether (PEGDME; polyglime), or a combination thereof.

5. The positive electrode active material as claimed in claim 1, wherein
the (meth)acrylate including the alkylene glycol unit, and the ether including the alkylene glycol unit each independently have a number average molecular weight of 200 g/mol to 2,000 g/mol.

6. The positive electrode active material as claimed in claim 1, wherein
in the coating layer, the organic material is included in an amount of 20 wt % to 90 wt % and the lithium salt is included in an amount of 10 wt % to 80 wt % based on a total of 100 wt % of the organic material and the lithium salt.

7. The positive electrode active material as claimed in claim 1, wherein
a total content of the organic material and the lithium salt is 0.1 parts by weight to 10 parts by weight based on 100 parts by weight of the positive electrode active material particles, and/or
the organic material is included in an amount of 0.05 wt % to 5 wt % and the lithium salt is included in an amount of 0.05 wt % to 5 wt % based on 100 wt % of the positive electrode active material.

8. (canceled)

9. The positive electrode active material as claimed in claim 1, wherein
the lithium salt includes LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro(oxalato)borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

10. The positive electrode active material as claimed in claim 1, wherein
the coating layer is present in a form of an island or a continuous film on the surface of the positive electrode active material particle, and
the coating layer has a thickness of 1 nm to 50 nm.

11. (canceled)

12. The positive electrode active material as claimed in claim 1, wherein
the lithium transition metal composite oxide is a lithium nickel-based oxide represented by Chemical Formula 1, a lithium cobalt-based oxide represented by Chemical Formula 2, a lithium iron phosphate-based compound represented by Chemical Formula 3, or a cobalt-free lithium nickel-manganese-based oxide represented by Chemical Formula 4: 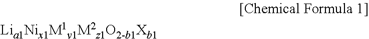
wherein, in Chemical Formula 1, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more elements selected from Al, B, Ba, Ca, Ce, Co, Cr, Cu, Fe, Mg, Mn, Mo, Nb, Si, Sn, Sr, Ti, V, W, Zn, and Zr, and X is one or more elements selected from F, P, and S, 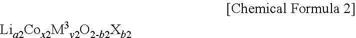
wherein, in Chemical Formula 2, 0.9≤a2≤1.8, 0.7≤x2≤1, 0≤y2≤0.3, 0.9≤x2+y21≤1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn and Zr, and X is one or more elements selected from F, P, and S, 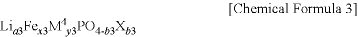
wherein, in Chemical Formula 3, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S, 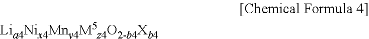
wherein, in Chemical Formula 4, 0.9≤a4≤1.8, 0.8≤x4≤1, 0≤y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

13. The positive electrode active material as claimed in claim 12, wherein
the lithium transition metal composite oxide is a lithium nickel-based oxide represented by Chemical Formula 1, and is a high nickel-based oxide satisfying 0.8≤x1<1, 0<y1≤0.2, and 0≤z1≤0.2, and/or
the lithium transition metal composite oxide is a lithium nickel-based oxide represented by Chemical Formula 1, and is a high nickel-based oxide satisfying 0.9≤x1<1, 0<y1≤0.1, and 0≤z1≤0.1.

14. (canceled)

15. The positive electrode active material as claimed in claim 1, wherein
the positive electrode active material particle has an average particle diameter (D50) of 1 μm to 25 μm.

16. The positive electrode active material as claimed in claim 1, wherein the positive electrode active material particles include small particles having an average particle diameter (D50) of 1 μm to 9 μm and large particles having an average particle diameter (D50) of 10 μm to 20 μm, and/or
the small particles are included in an amount of 5 to 40 wt % and the large particles are included in an amount of 60 to 95 wt %, based on 100 wt % of the total of the small particles and the large particles and/or
the small particles and large particles in a form of secondary particles in which a plurality of primary particles are agglomerated, or
the small particles are in a form of single particles, and the large particles are in a form of secondary particles in which a plurality of primary particles are agglomerated.

17. (canceled)

18. (canceled)

19. (canceled)

20. The positive electrode active material as claimed in claim 1, wherein
the positive electrode active material further includes a buffer layer between the positive electrode active material particles and the coating layer,
the buffer layer includes a lithium compound and a metal oxide, and the metal is at least one selected from Al, B, Ca, Ce, Cr, Fe, Mg, Mo, Nb, Si, Sn, Sr, Ta, V, W, and Zr.

21. A method for preparing a positive electrode active material, comprising
mixing an organic material and a lithium salt to prepare a composite, and mixing the composite with positive electrode active material particles including a lithium transition metal composite oxide and drying the composite to coat the surface of the positive electrode active material particles with the composite,
wherein the organic material includes a (meth)acrylate including an alkylene glycol unit, an ether including an alkylene glycol unit, or a combination thereof.

22. The method for preparing a positive electrode active material as claimed in claim 21, wherein
the organic material is mixed in an amount of 0.05 parts by weight to 5 parts by weight and the lithium salt is mixed in an amount of 0.05 parts by weight to 5 parts by weight based on 100 parts by weight of the positive electrode active material particles, and/or
the organic material and the lithium salt are mixed in a weight ratio of 2:8 to 9:1 and/or
the drying is performed at a temperature range of 60° C. to 150° C.

23. (canceled)

24. (canceled)

25. A positive electrode for an all-solid-state rechargeable battery comprising the positive electrode active material as claimed in claim 1, and a sulfide-based solid electrolyte.

26. The positive electrode for an all-solid-state rechargeable battery as claimed in claim 25, wherein
the sulfide-based solid electrolyte includes an argyrodite-type sulfide, and/or
the sulfide-based solid electrolyte is in a form of particles and has an average particle diameter (D50) of 0.1 μm to 1.9 μm and/or
the positive electrode active material is included in an amount of 65 to 99 wt %, and the sulfide-based solid electrolyte is included d in an amount of 1 to 35 wt %, based on 100 wt % of a total amount of the positive electrode active material and the sulfide-based solid electrolyte.

27. (canceled)

28. (canceled)

29. The positive electrode for an all-solid-state rechargeable battery as claimed in claim 25, wherein
the positive electrode further includes a conductive material, and
the conductive material includes natural graphite, artificial graphite, carbon black, acetylene black, ketjen black, a carbon nanofiber, a carbon nanotube, or a combination thereof, and/or
the positive electrode does not include a fluorine-based binder.

30. (canceled)

31. An all-solid-state rechargeable battery, comprising
the positive electrode as claimed in claim 25,
a negative electrode and
a solid electrolyte layer between the positive electrode and negative electrode
the negative electrode comprises a current collector and a negative electrode coating layer located on the current collector and including a lithiophilic metal, a carbon material, or a combination thereof, and
a lithium metal layer formed by charging between the current collector and the negative electrode coating layer is included.

32. (canceled)
